(19) United States
(12) Patent Application Publication
(10) Pub. No.: US 2009/0021793 A1
(43) Pub. Date: Jan. 22, 2009

(54) IMAGE PROCESSING DEVICE, IMAGE PROCESSING METHOD, PROGRAM FOR EXECUTING IMAGE PROCESSING METHOD, AND STORAGE MEDIUM FOR STORING PROGRAM

(75) Inventors: Ling Lu, Tokyo (JP); Kitahiro Kaneda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/815,893

(22) PCT Filed: Apr. 7, 2006
(86) PCT No.: PCT/JP2006/307888

§ 371 Date: Aug. 9, 2007

(30) Foreign Application Priority Data
Apr. 12, 2005 (JP) 2005-114532

(51) Int. Cl. H04N 1/40; G06K 9/00

(52) U.S. Cl. 358/3.28; 382/100

(57) ABSTRACT

To provide image processing device and method which can achieve embedding and extracting of watermark message which secures certain or more message embedding accuracy and amount as suppressing deterioration of quality in an original document image, it inputs a document image to an image input unit, it extracts by an image analysis unit a character image included in the input document image, and it embeds by an embedding unit watermark message by constituting the character image by means of a predetermined dot pattern.

### TECHNICAL FIELD

The present invention relates to a technique for embedding the message to a document image and extracting the embedded message.

### BACKGROUND ART

In recent years, the image quality of an image generated by a digital image formation device such as a printer, a copying machine or the like improves remarkably, whereby it is possible to easily acquire a high-quality printed material. In other words, it is possible for everyone to acquire the demanded printed material through an image process by using high-end scanner, printer, copying machine and computer, whereby the problems of unauthorized copy, alteration and the like of document occur. For this reason, in order to prevent or suppress these problems, the movement of embedding access control information to the printed material itself as watermark message becomes active in recent years.

As the watermark message having such a function, there is an invisible digital watermark, which is acquired by invisibly embedding the access control information to the printed material. Here, as a general method of achieving the invisible watermark message, there are proposed a method of the type of embedding message by controlling an amount of spaces in an English word string (for example, U.S. Pat. No. 6,086,706), a method of the type of rotating a character, a method of the type of enlarging and reducing the size of a character, a method of the type of embedding message as deforming a character, and the like.

However, in the method of invisibly embedding the message as above, incompatibility occurs in regard to the spaces and the deformed characters particularly in the document image, whereby deterioration of quality in the original document image becomes remarkable.

### DISCLOSURE OF THE INVENTION

The present invention has been completed in consideration of the above point, and an object thereof is to provide image processing device and method which can achieve embedding and extracting of watermark message which secures certain or more message embedding accuracy and amount as suppressing deterioration of quality in an original document image.

To attain the above object, the present invention is characterized by an image processing device which comprises an image input unit adapted to input a document image, an extraction unit adapted to extract a character image included in the input document image, and an embedding unit adapted to embed watermark message by constituting the character image by means of a predetermined dot pattern.

Further, the present invention is characterized by an image processing device which comprises an image input unit adapted to input a watermarked document image, an acquisition unit adapted to acquire dot pattern information indicating a dot pattern constituting a character image included in the input document image, and an extraction unit adapted to extract the watermark message based on the acquired dot pattern information.

Furthermore, the present invention is characterized by an image processing method which comprises an image input step of inputting a document image, an extraction step of extracting a character image included in the input document image, and an embedding step of embedding watermark message by constituting the character image by means of a predetermined dot pattern.

Moreover, the present invention is characterized by an image processing method which comprises an image input step of inputting a watermarked image, an acquisition step of acquiring dot pattern information indicating a dot pattern constituting a character image included in the input document image, and an extraction step of extracting the watermark message based on the acquired dot pattern information.

Other features and advantages of the present invention will become apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate the embodiments of the invention and, together with the description, serve to explain the principles of the invention.

FIG. 1 is a block diagram showing the constitution of the watermark message embedding device according to the present invention;

FIG. 2 is a block diagram showing the electronic configuration of the watermark message embedding device and the watermark message extraction device according to the present invention;

FIG. 3 is a flow chart for explaining the operation procedure of the watermark message embedding device according to the first embodiment;

FIG. 4 is a block diagram for explaining the changes of a character before and after the embedding of the watermark message according to the first embodiment;

FIG. 5 is a flow chart for explaining the watermark message embedding method according to the first embodiment;

FIGS. 6A and 6B are flow charts showing the process of the step S306 in the first embodiment;

FIGS. 7A, 7B and 7C are diagrams for explaining the states before and after the embedding of the watermark message according to the first embodiment;

FIG. 8 is a block diagram showing the constitution of the watermark message extraction device according to the present invention;

FIG. 9 is a flow chart for explaining the operation procedure of the watermark message extraction device according to the first embodiment;

FIG. 10 is a flow chart for explaining the watermark message extraction method according to the first embodiment;

FIG. 11 is a flow chart for explaining the method of calculating the similarity according to the first embodiment;

FIG. 12 is a diagram for explaining the changes of a character before and after the embedding of the watermark message according to the modification 1 of the first embodiment;

FIG. 13 is a flow chart showing the process of the step S306 in the modification 1 of the first embodiment;

FIG. 14 is a flow chart showing the process of the step S306f in the modification 1 of the first embodiment;

FIG. 15 is a diagram for explaining the flow of the watermark message embedding in the modification 1 of the first embodiment;

FIG. 16 is a diagram showing the operator expression for detecting the feature point in the modification 1 of the first embodiment;

FIG. 17 is a flow chart for explaining the operation procedure of the watermark message embedding device according to the modification 2 of the first embodiment;

FIG. 18 is a block diagram for explaining the changes of a character before and after the embedding of the watermark message according to the modification 2 of the first embodiment;

FIG. 19 is a flow chart for explaining the operation procedure of the watermark message extraction device according to the modification 2 of the first embodiment;

FIG. 20 is a diagram for explaining a size change of the pattern for extracting the watermark message in the second embodiment;

FIG. 21 is a flow chart for explaining the step S805 in the second embodiment;

FIG. 22 is a flow chart for explaining the step S805f in the second embodiment;

FIG. 23 is a diagram for explaining the nearest neighbor method;

FIG. 24 is a diagram for explaining the linear interpolation method;

FIG. 25 is a flow chart for explaining the step S805f1 in the modification 1 of the second embodiment;

FIG. 26 is a flow chart for explaining the angle adjustment of a document image in the third embodiment;

FIG. 27 is a diagram for explaining the fine adjustment of an input image in the third embodiment;

FIG. 28 is a flow chart for explaining the step S302b in the third embodiment;

FIG. 29 is a diagram for explaining the document image after the angle adjustment in the third embodiment;

FIG. 30 is a flow chart for explaining the step S302 in the modification 1 of the third embodiment; and

FIG. 31 is a flow chart for explaining the step S302a in the modification 2 of the third embodiment.

### BEST MODE FOR CARRYING OUT THE INVENTION

The preferred embodiments of the present invention will now be described in detail with reference to the accompanying drawings.

### First Embodiment

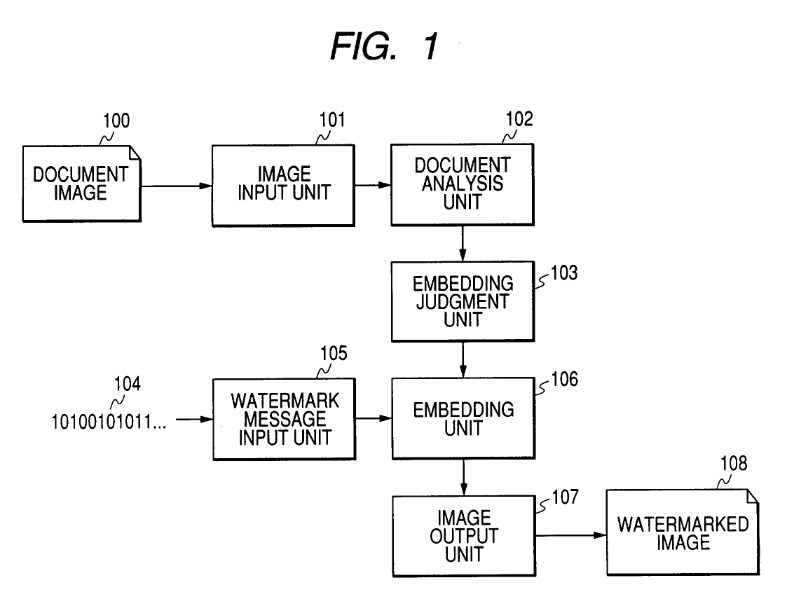

FIG. 1 is a block diagram showing the constitution of the watermark message embedding device according to the present invention. As shown in FIG. 1, a document image 100 to which watermark message should be embedded is first input to an image input unit 101, and the positional relation of the characters in the input document image 100 is analyzed in a document analysis unit 102. Further, an embedding judgment unit 103 judges it whether or not a watermark message can be embedded in the document image 100. Then, in an embedding unit 106, the watermark message is actually embedded in the document image 100 based on watermark message 104 input through a watermark message input unit 105. Here, it should be noted that the image in which the digital watermark has been embedded is called a watermarked image. In any case, a watermarked image 108 is output by an image output unit 107.

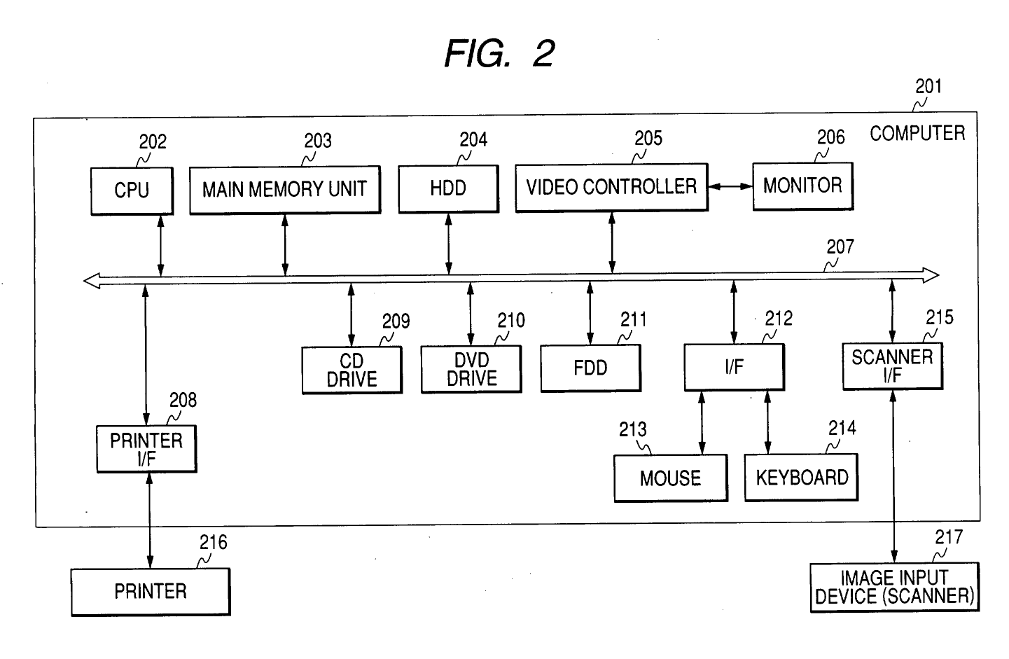

FIG. 2 is a block diagram showing the electronic configuration of the watermark message embedding device and the watermark message extraction device according to the present invention. Here, it should be noted that, to achieve the watermark message embedding device and the watermark message extraction device in the present invention, it is unnecessary to use all the functions shown in FIG. 2.

In FIG. 2, a computer 201, which is the general-purpose information processing device such as a popular personal computer or the like, can input the image data representing the image read by an image input device 217 such as a scanner or the like (for convenience, image input device 217 can be also called scanner 217 hereinafter), process the input image data, and store the processed image data. Further, a printer 216 can print the image data acquired by the image input device 217. Incidentally, various indications and the like from a user are input by the user's input operation through a mouse 213 and a keyboard 214. In the computer 201, later described various blocks are mutually connected through the bus to as to be able to exchange various data.

In FIG. 2, a CPU 202 can control the operations of the respective blocks included in the computer 201, and also execute the programs stored in the computer 201. A main memory unit 203 consisting of a RAM is the device which temporarily stores the programs and the process-target image data for the process to be executed in the CPU 202, and an HDD (hard disk drive) 204 is the device which can previously store the programs and the image data to be transferred to the main memory unit 203 or the like and further store the image data after the process.

A scanner I/F (interface) 215 is the interface which is connected to the scanner 217 of reading an original, a film and the like and generating the corresponding image data, and can input the image data from the scanner 217. A printer I/F 208 is the interface, which is connected to the printer 216 of printing the image data, and can transmit to the printer 126 the image data to be printed.

A CD drive 209 is the device capable of reading and writing the data from and to a CD (CD-R/CD-RW) being one of external storage media. An FDD (flexible disk drive) 211 is the device, as well as the CD drive 209, capable of reading and writing the data from and to an FD (flexible disk). A DVD (digital versatile disc) drive 210 is the device, as well as the FDD 211, capable of reading and writing the data from and to a DVD. Incidentally, if the program such as an image processing program, a printer driver or the like has been stored in a CD, an FDD, a DVD or the like, the relevant program is once installed onto the HDD 204, and the installed program or driver is then transferred to the main memory unit 203 according to need.

An I/F 212 is the interface, which is connected to the mouse 213 and the keyboard 214 so as to accept the indications input therefrom. Further, a monitor 206 is the display device capable of displaying the results, passages and the like of the watermark message embedding and extraction processes, and a video controller 205 is the device for transmitting the display data to the monitor 206.

Incidentally, the present invention is applicable to the system, which is constituted by plural devices (e.g., a host computer, an interface device, a reader, a printer, and the like), or to the device, which comprises a single unit (e.g., a copying machine, a facsimile machine, or the like).

In the above configuration, if the program is loaded to the main memory unit 203 and executed by the CPU 202 in response to the indication from the mouse 213 or the keyboard 214, the computer 201 functions as the watermark message embedding device or the watermark message extraction device. At that time, the user can see the execution progress and the result of the watermark message embedding and extraction processes, through the monitor 206.

Hereinafter, the watermark message embedding method and the watermark message extraction method will be explained concretely.

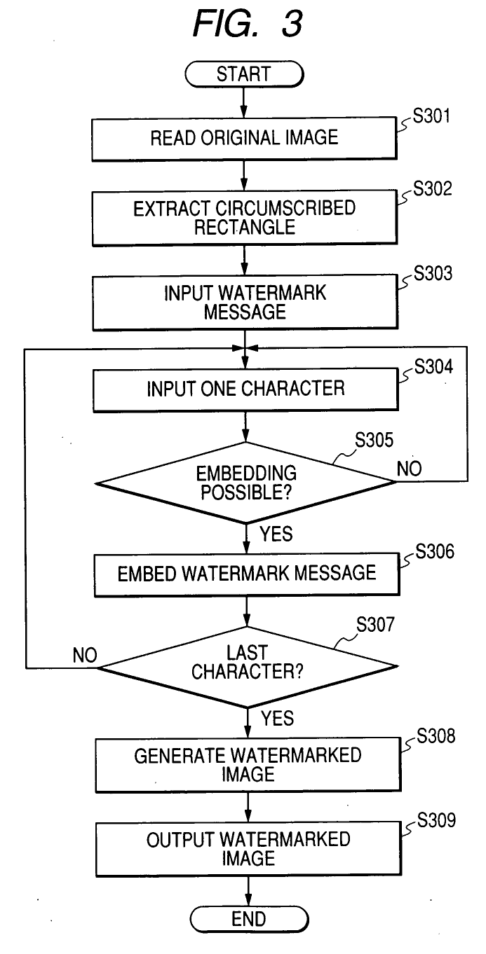

FIG. 3 is a flow chart for explaining the operation procedure of the watermark message embedding device according to the present embodiment.

Initially, in a step S301, the original document image 100 to which the watermark message is to be embedded is input to the document analysis unit 102 through the image input unit 101. Here, it should be noted that, if the image data input through the scanner 217 or the like and extracted into the bitmap data or if the electronic data is generated by using the document processing application program, the acquired electronic data can be used as the document image 100. Alternatively, if the various electronic data such as the data of the format inherent in the application program stored in the storage medium connected to the HDD 204, the CD drive 209, the DVD drive 210 or the FDD 211, the data of the text format, and the like are converted and extracted into the bitmap data by using the image processing software or the like, the acquired electronic data can be used as the document image 100.

Then, in a step S302, a circumscribed rectangle (i.e., character region) is extracted from the input document image by the document analysis unit 102. Here, it should be noted that the circumscribed rectangle of a character is the rectangle, which is externally in contact with the relevant character, and the circumscribed rectangle originally implies the information indicating the region to which character recognition is executed. However, in the watermark message technique, the circumscribed rectangle represents the character region to which the embedding operation is executed. More specifically, each pixel value in the document image is projected in regard to the vertical coordinate axis, the row is discriminated by searching a blank portion (that is, the portion not including a character being the black portion), and the discriminated row is divided. After then, the document image is projected in regard to the horizontal coordinate axis in units of divided row, and the acquired image is further divided in units of character similarly by searching the blank portion, whereby each character is cut out with the circumscribed rectangle thereof.

Then, if the circumscribed rectangle is extracted as above, in a step S303, the watermark message 104 that the user wishes to embed is input from the watermark message input unit 105. Here, it should be noted that the watermark message 104 may be input through the keyboard 214 or selected from among those previously stored in the memory unit.

Next, in a step S304, one character is input. Then, in a step S305, it is judged by the embedding judgment unit 103, before the watermark message is actually embedded, whether or not the relevant watermark message can be embedded in the input character in the region of the circumscribed rectangle. By the process in the step S305, only the character of which the size is larger than the region which has been previously determined so that the watermark message can be extracted therefrom even if scanning is executed is selected. That is, too small character, symbol and the like are excluded from the embedding target.

If it is judged that the watermark message cannot be embedded in the input character (NO in step S305), the flow returns to the step S304 to input next one character. Meanwhile, if it is judged that the watermark message can be embedded in the input character (YES in step S305), the flow advances to a step S306 to cause the embedding unit 106 to embed the watermark message.

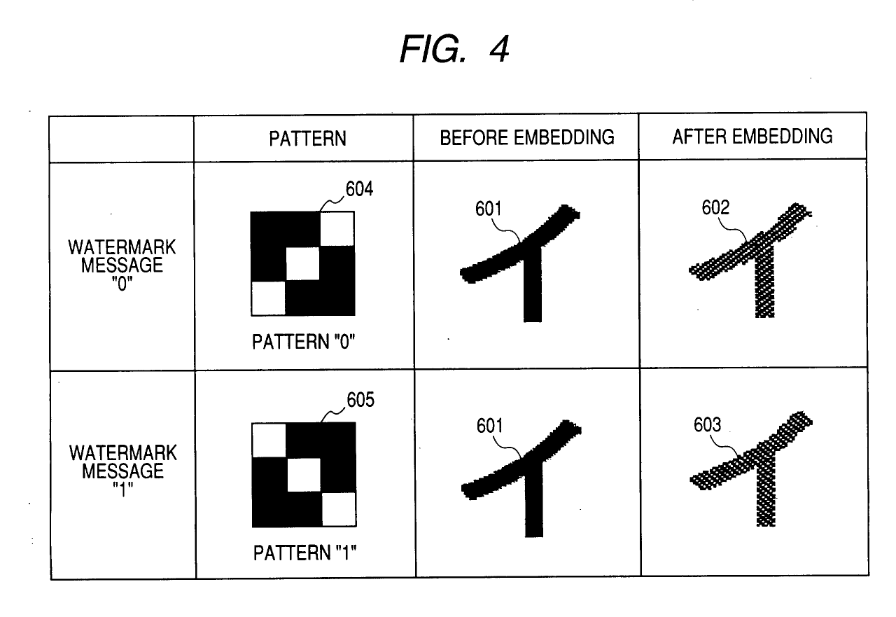

Hereinafter, the method which is executed by the embedding unit 106 to embed the watermark message will be explained. That is, in the relevant method, two different patterns are prepared, and the watermark message is embedded in the character by using these patterns respectively. For example, if watermark message “1” is embedded in the character, the character is constituted by using a pattern “1” denoted by numeral 605 shown in FIG. 4. Moreover, if watermark message “0” is embedded in the character, the character is constituted by using a pattern “0” denoted by numeral 604 shown in FIG. 4.

FIG. 4 is the block diagram for explaining the changes of the character before and after the embedding of the watermark message according to the present embodiment.

In FIG. 4, numeral 601 denotes the character before the embedding of the watermark message (that is, the watermark message is not embedded in the character 601), numeral 602 denotes the character which is acquired after the watermark message “0” was embedded in the character 601 by using the pattern “0”, and numeral 603 denotes the character which is acquired after the watermark message “1” was embedded in the character 601 by using the pattern “1”. That is, the watermark message is embedded by constituting the character with use of the pattern “0” (604) and the pattern “1” (605).

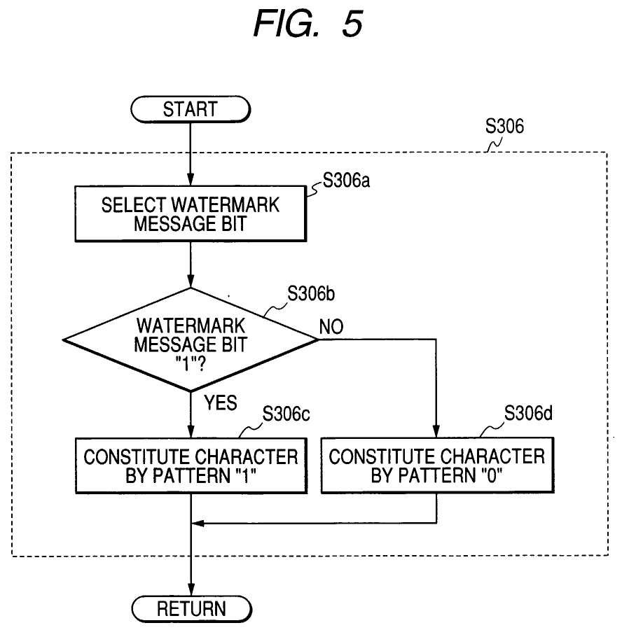

FIG. 5 is a flow chart for explaining the watermark message embedding method according to the present embodiment.

First, in a step S306a, the bits to be embedded are selected from the watermark message 104. Here, it should be noted that one-bit message is embedded in one character in the present embodiment. Thus, for example, if the message “101001 . . . ” has been input as the watermark message, the bit to be first selected is the head bit “1”, and the bit to be next selected is the bit “0”.

In a step S306b, it is judged whether or not the bit of the watermark message to be embedded is “1”.

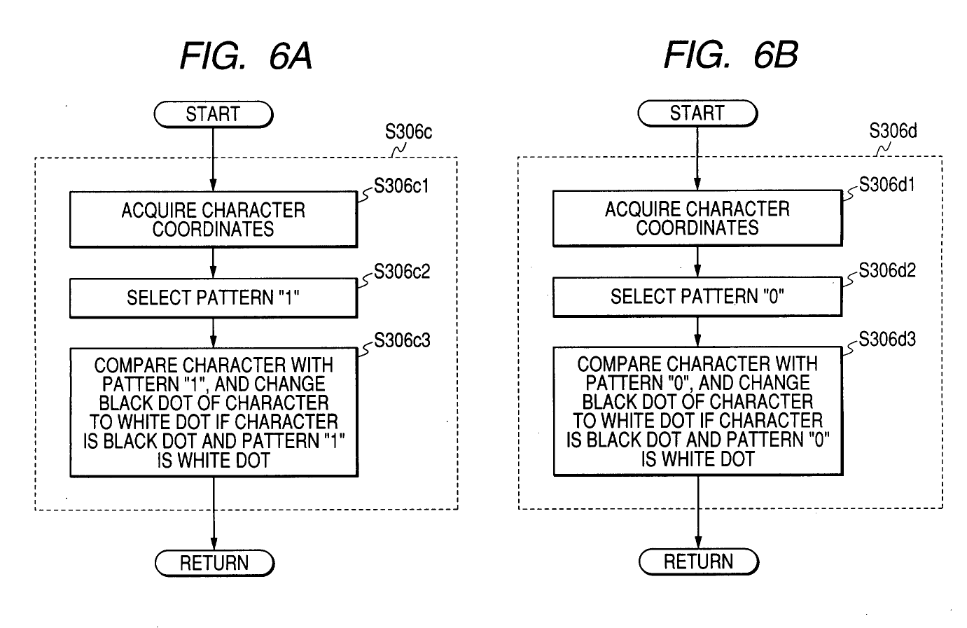

If it is judged in the step S306b that the bit of the watermark message to be embedded is “1” (YES in step S306b), the flow advances to a step S306c to constitute the character by using the pattern “1”. Here, the detail of the process in the step S306c will be explained with reference to a flow chart shown in FIG. 6A.

FIG. 6A is the flow chart for explaining the method of constituting the character by using the pattern “1”.

First, in a step S306c1, the coordinates of the character in which the watermark message is embedded (that is, the character being the watermark message embedding target) are acquired. Here, it should be noted that the character coordinates are the coordinates of the circumscribed rectangle of the character acquired in the step S302.

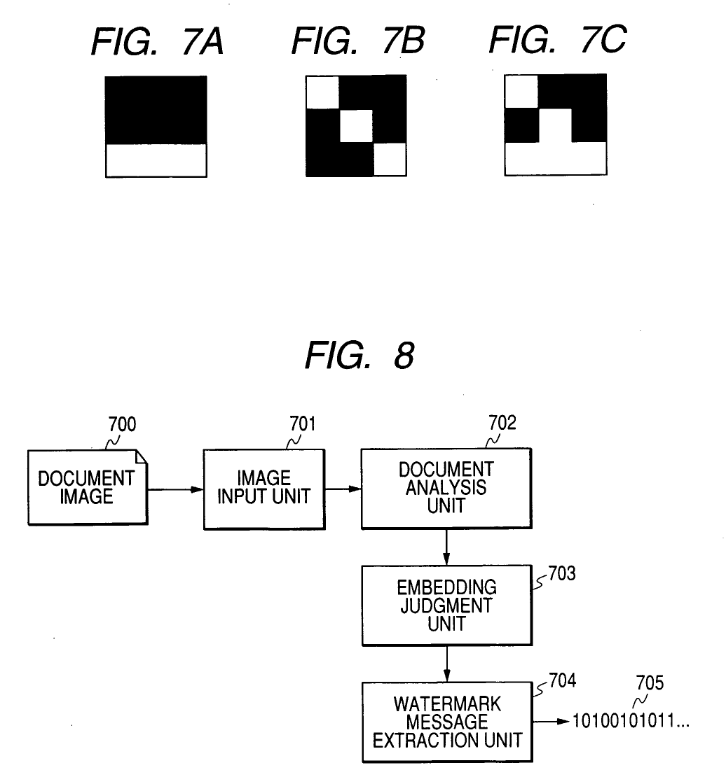

Next, in a step S306c2, the pattern “1” is selected. Then, in a step S306c3, the circumscribed rectangular region of the character is divided into the region of which the size is equivalent to that of the pattern “1”, and the dot of the circumscribed rectangular region of the character and the dot of the dot pattern “1” are compared with each other for each of the divided circumscribed rectangular region of the character. Consequently, if the dot of the circumscribed rectangular region of the character (see FIG. 7A) is the black dot and the dot of the pattern “1” at the same location (see FIG. 7B) is the white dot, the black dot in the circumscribed rectangular region of the character is changed to the white dot. In other cases, any dot is not changed. Incidentally, FIG. 7C shows the dot of the circumscribed rectangular region of the character after the above change. If the relevant process is executed to the circumscribed rectangular region of the character, the character is constituted by using the pattern “1”.

On the other hand, if it is judged in the step S306b that the bit of the watermark message to be embedded is “0” (NO in step S306b), the flow advances to a step S306d to constitute the character by using the pattern “0”. Here, the detail of the process in the step S306d will be explained with reference to a flow chart shown in FIG. 6B. Here, it should be noted that the flow chart shown in FIG. 6B is different from that shown in FIG. 6A only in the point that the pattern to be used in FIG. 6B is different from that to be used in FIG. 6A.

First, in a step S306d1, the coordinates of the character being the watermark message embedding target are acquired. Next, in a step S306d2, the pattern “0” is selected. Then, in a step S306d3, the circumscribed rectangular region of the character is divided into the region of which the size is equivalent to that of the pattern “0”, and the dot of the circumscribed rectangular region of the character and the dot of the dot pattern “0” are compared with each other for each of the divided circumscribed rectangular region of the character. Consequently, if the dot of the circumscribed rectangular region of the character is the black dot and the dot of the pattern “0” at the same location is the white dot, the black dot in the circumscribed rectangular region of the character is changed to the white dot. In other cases, any dot is not changed. If the relevant process is executed to the circumscribed rectangular region of the character, using the pattern “0” constitutes the character.

Then, in a step S307, it is judged whether or not the relevant character is the last character in the document image. Consequently, if it is judged that the relevant character is the last character (YES in step S307), the flow advances to a step S308 to end the embedding process of the bit of the watermark message and generate, based on the information of the pattern changed by the embedding unit 106, the watermarked image. Subsequently, the watermarked image is output from the image output unit 107 (step S309). Incidentally, it should be noted that, for example, the watermarked image may be printed by the printer, stored as the image data in the memory unit, or transmitted to another terminal through the network. On the other hand, if it is judged in the step S307 that the relevant character is not the last character (NO in step S307), the flow returns to the step S304 to input next one character.

FIG. 8 is a block diagram showing the constitution of the watermark message extraction device according to the present invention. As shown in FIG. 8, a watermarked document image 700 is input to an image input unit 701, and the positional relation of the characters in the input document image 700 is analyzed in a document analysis unit 702. Further, it is judged by an embedding judgment unit 703 whether or not the watermark message has been embedded in the document image 700. Then, in a watermark message extraction unit 704, the watermark message is actually extracted from the document image 700, whereby watermark message 705 is output.

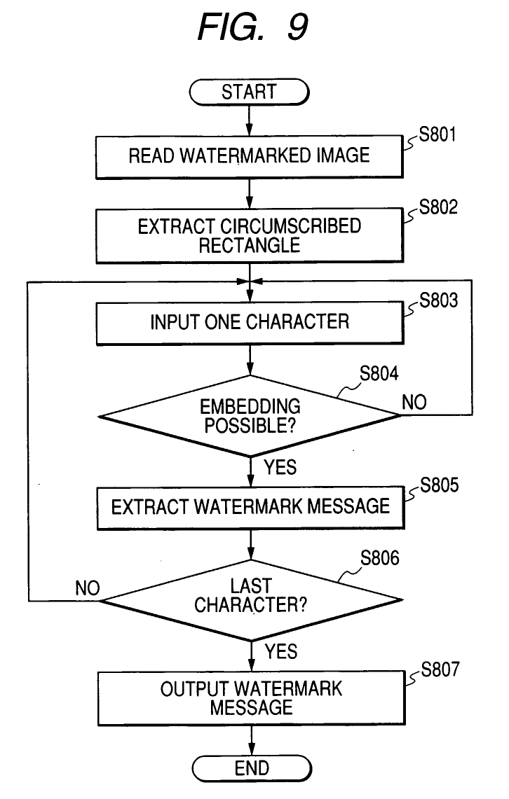

FIG. 9 is a flow chart for explaining the operation procedure of the watermark message extraction device according to the present embodiment.

Initially, in a step S801, the watermarked document image is input. More specifically, the document image 700 from which the watermark message is to be extracted is input to the document analysis unit 702 through the image input unit 701. Here, it should be noted that, if the image data input through the scanner 217 or the like and extracted into the bitmap data or if the electronic data is generated by using the document processing application program, the acquired electronic data can be used as the document image 700. Alternatively, if the various electronic data such as the data of the format inherent in the application program stored in the storage medium connected to the HDD 204, the CD drive 209, the DVD drive 210 or the FDD 211, the data of the text format, and the like are converted and extracted into the bitmap data by using the image processing software or the like, the acquired electronic data can be used as the document image 700.

Then, in a step S802, the circumscribed rectangle, i.e., the character region, is extracted from the input document image by the document analysis unit 702. Here, it should be noted that the process in the step S802 is the same as that in the step S302.

Next, in a step S803, one character is input. Then, in a step S804, the embedding judgment unit 703 judges it whether or not the region of the circumscribed rectangle of the input character is the region of the character in which the watermark message has been embedded. Here, it should be noted that the embedding judgment unit 703, which is the same as the embedding judgment unit 103 shown in FIG. 1, could accurately judge the character in which the watermark has been embedded.

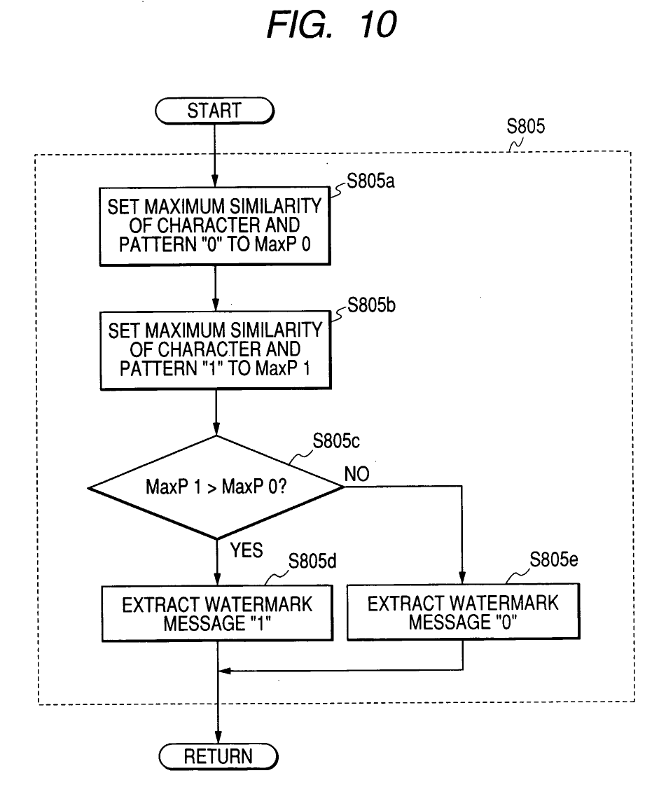

If it is judged in the step S804 that the watermark message has been embedded in the input character (YES in step S804), the flow advances to a step S805 to extract the watermark message by the watermark message extraction unit 704. Meanwhile, if it is judged in the step S804 that the watermark message is not embedded in the input character (NO in step S805), the flow returns to the step S803 to input next one character. Here, the detail of the step S805 will be explained with reference to a flow chart shown in FIG. 10.

FIG. 10 is the flow chart for explaining the watermark message extraction method according to the first embodiment.

First, in the character region from which the watermark message is to be extracted (also called the watermark message extraction target character region), it cross-correlates the character with the pattern “0” to acquire the maximum similarity MaxP0. More specifically, the pattern “0” is the pattern “0” which was used when the watermark message was embedded, and the maximum similarity acquired by cross-correlating the character with the pattern “0” is set as the maximum similarity MaxP0. Incidentally, it is assumed that the watermark message extraction target character region (from which the watermark message is to be extracted) is the region of the circumscribed rectangle of the character acquired in the step S802.

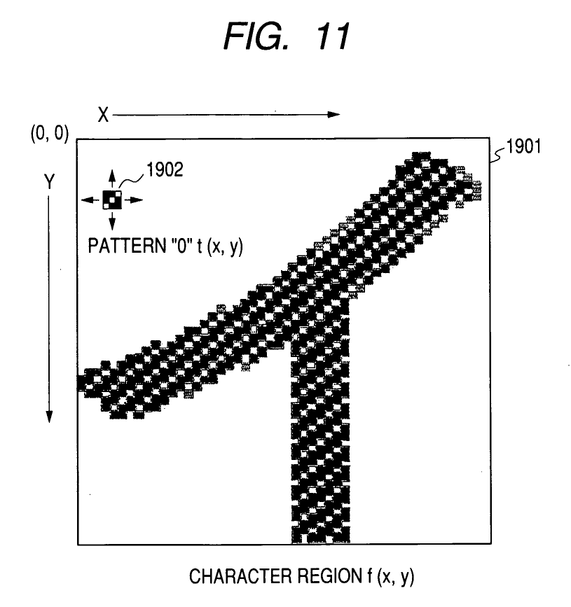

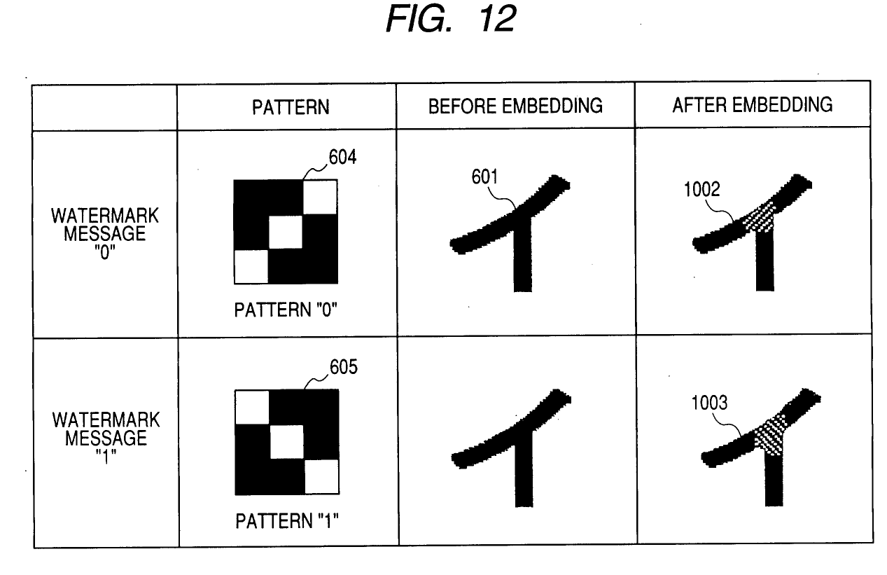

Here, the method of calculating the maximum similarity of a certain Japanese character (pronounced “ye”) being the watermark message extraction target will be explained with reference to FIG. 11. In FIG. 11, the coordinates on a character region 1901 are set f(x, y) and the coordinates on the pattern “0” denoted by numeral 1902 are t(x, y). Then, it calculates the similarity sequentially as shifting on the character region f(x, y) the pattern “0” t(x, y) in the X and Y directions image by image, to acquire the maximum value thereof. Thus, the maximum similarity is acquired.

That is, the maximum peak appears at the location where the pattern constituting the character conforms to the pattern “0”. Then, it is possible from the appeared peak to judge or discriminate that the pattern “0” has been embedded at the relevant location.

Here, the similarity is expressed by the cross correlation indicated by the equation (1).

gᵢ(u,v)=∫∫ₛt(x,y)f(x+u,y+v)dxdy (i=1, . . . , M) (1)

Where “s” is the area of the pattern “0”.

Thus, the maximum peak of the similarity distribution gᵢ(x, y) is detected, and the detected value is set the maximum similarity MaxP0 (step S805a).

Subsequently, by using the same method, it cross-correlates the character with the pattern “1” in the character region to acquire the maximum similarity MaxP1 (step S805b). More specifically, the pattern “1” is the pattern “1” which was used when the watermark message was embedded, and the maximum similarity acquired by cross-correlating the character with the pattern “1” is set as the maximum similarity MaxP1.

Next, it is judged whether or not MaxP1 is larger than MaxP0 (step S805c). As a result, if it is judged that MaxP1 is larger than MaxP0 (YES in step S805c), “1” is extracted as the watermark message (step S805d). Meanwhile, if it is judged that MaxP1 is smaller than MaxP0 (NO in step S805c), “0” is extracted as the watermark message (step S805e).

Incidentally, in the steps S805a and S805b, it is also possible to calculate plural (e.g., ten) maximum values from the similarity distribution to acquire mean MaxP0 and mean MaxP1. Moreover, it is needless to say that the processing order of the steps S805a and S805b can be inverted.

Next, in a step S806, it is judged whether or not the character input in the step S803 is the last character. If it is judged that the input character is the last character (YES in step S806), the watermark message is output (step S807), and the process ends. Meanwhile, if it is judged that the input character is not the last character (NO in step S806), the flow returns to the step S803 to continue the process.

### <Modification 1>

The modification 1 of the first embodiment will be explained hereinafter. That is, the present invention is further modified so as to constitute a part (not the whole) of the character by using the pattern to reduce the area of deformation of the character, thereby obscuring the deformation. Here, it should be noted that the constitution and the processing procedure necessary in the operation of the modification 1 are the same as those necessary in the operation of the first embodiment except for the step S306. Therefore, in the following, only the point different from the first embodiment will be explained in detail.

FIG. 12 is a diagram for explaining the changes of the character before and after the embedding of the watermark message, according to the modification 1. More specifically, the character before the embedding, the pattern “0” and the pattern “1” in the modification 1 are the same as those in the first embodiment, that is, the character after the embedding of the watermark message in the modification 1 is different from that in the first embodiment.

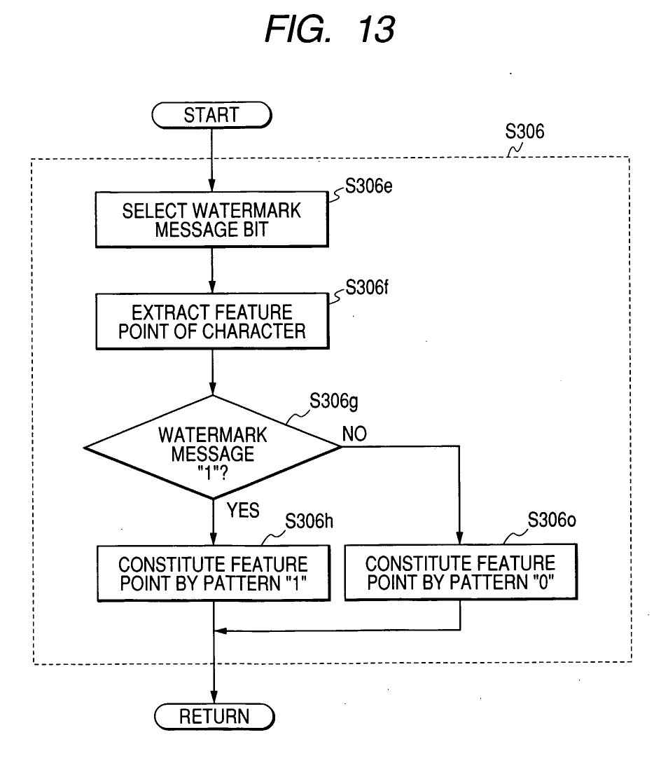

FIG. 13 is a flow chart showing the process of the step S306 in the modification 1.

Initially, in a step S306e, the bit to be embedded is selected from the watermark message 104.

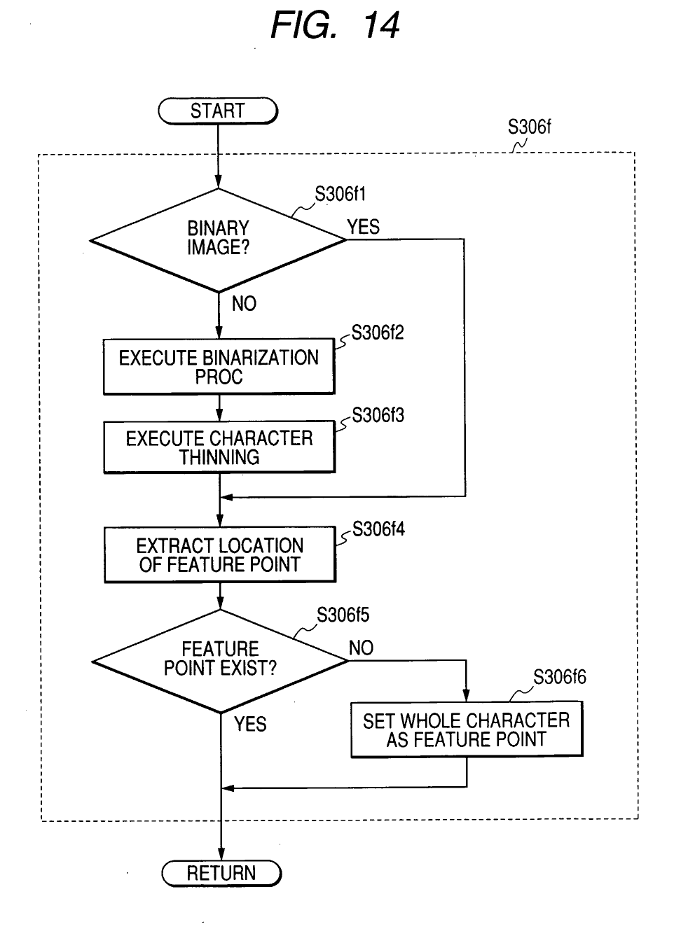

In a step S306f, the character to which the watermark message is to be embedded is selected, and the feature point of the selected character is extracted. Here, the processing procedure in the step S306f will further be explained in detail with reference to FIG. 14.

FIG. 14 is the flow chart showing the process of extracting the intersection of the character.

First, in a step S306f1, it is judged whether or not the input character image is a binary image. If it is judged that the input character image is not a binary image (NO in step S306f1), the flow advances to a step S306f2 to execute a binarization process to the input character. Here, it should be noted that, in the binarization process, in a case where the input image is a multivalued image, the pixel which is smaller than a certain shading value is set to a black pixel, and the pixel which is larger than the certain shading value is set to a white pixel. Further, it should be noted that the binarization process is the preprocess of a character thinning process. In any case, if it is judged that the input character image is a binary image (YES in step S306f1), the flow advances to a step S306f3.

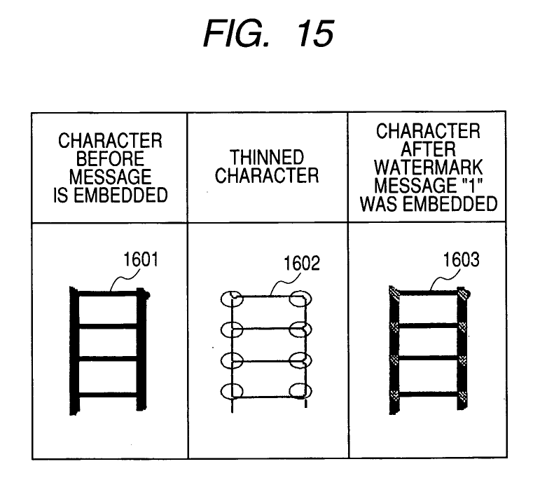

In the step S306f3, the binarized character image is subjected to the character thinning process. Here, it should be noted that the character thinning process is the process of extracting the center line of with the line width is “1” from the binarized image. In the modification 1, the character thinning process is executed by using the Hildith's thinning method, which is one of the basic character thinning methods. Here, it should be noted that the Hildith's thinning method is described in detail in “Introduction to Image Processing Using Programming Language C”; Takeshi AGUI, Tomoharu NAGAO; Shokodo; November 2000; ISBN: 4785631244. If a Japanese character 1601 (kanji character representing “eye”) before the embedding of the watermark message as shown in FIG. 15 is subjected to the character thinning process by using the Hildith's thinning method, a thinned character 1602 is acquired.

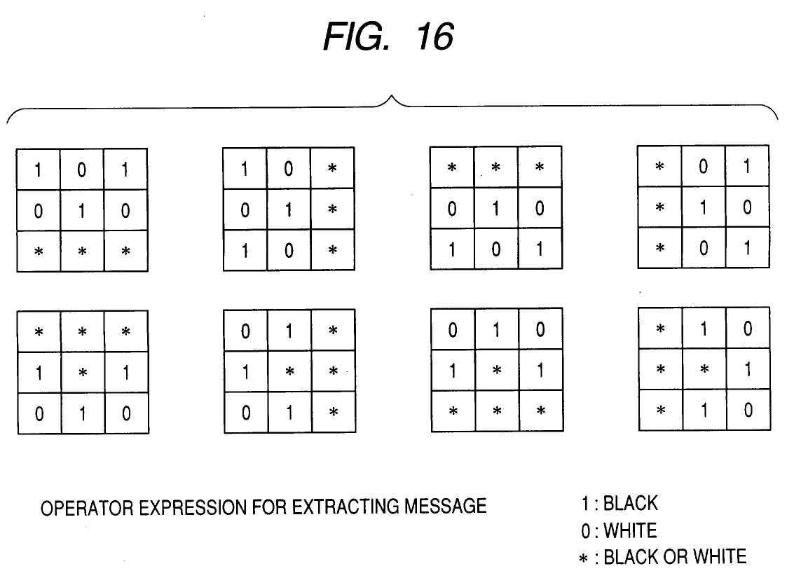

Then, the intersection which is the feature point is extracted from the thinned character image (step S306f4). More specifically, in the step S306f4, the eight pixels which surround the target point where the character image exists are first checked. Then, if the values of the checked eight pixels are the same as those of the operator expression shown in FIG. 16, the relevant target point is judged as the intersection.

Subsequently, in a step S306f5, it is judged whether or not the feature point is extracted. If it is judged that the feature point is not extracted (NO in step S306f5), the flow advances to a step S306f6 to set the whole character as one feature point.

In any case, if the feature point is extracted in the step S306f, the flow advances to a step S306g to judge whether or not the bit of the watermark message to be embedded is “1”, that is, whether or not the bit selected in the step S306e is “1”.

If it is judged in the step S306g that the bit of the watermark message to be embedded is “1” (YES in step S306g), the flow advances to a step S306h to constitute by the pattern “1” all the feature points of the character extracted in the step S306f. For example, if all the feature points of the character 1601 before the embedding shown in FIG. 15 are constituted by using the pattern “1”, a character 1603 after the embedding is acquired. On the other hand, if it is judged in the step S306g that the bit of the watermark message to be embedded is “0” (NO in step S306g), the flow advances to a step S306o to constitute by the pattern “0” the feature point of the character extracted in the step S306f.

Incidentally, it should be noted that the procedure for extracting the embedded watermark message is substantially the same as that in the first embodiment.

Thus, in the modification 1 of the first embodiment, since the area of deformation of the character after the watermark message was embedded is small, the relevant deformation is obscured for users.

Moreover, instead of embedding one watermark message bit in one character, it is possible to embed a watermark message bit with respect to each intersection of one character. In this case, since it is possible to embed plural watermark message bits to the character which has the plural intersections, it is possible to embed further many message data.

### <Modification 2>

Subsequently, the modification 2 of the first embodiment will be explained hereinafter. That is, the present invention is further modified so as to embed, by using three patterns, the different patterns, i.e., the pattern “1” and the pattern “0”, in the character in which any watermark message is not to be embedded, thereby preventing that the character in which the watermark message has not been embedded is erroneously recognized on the extraction side as the character in which the watermark message has been embedded.

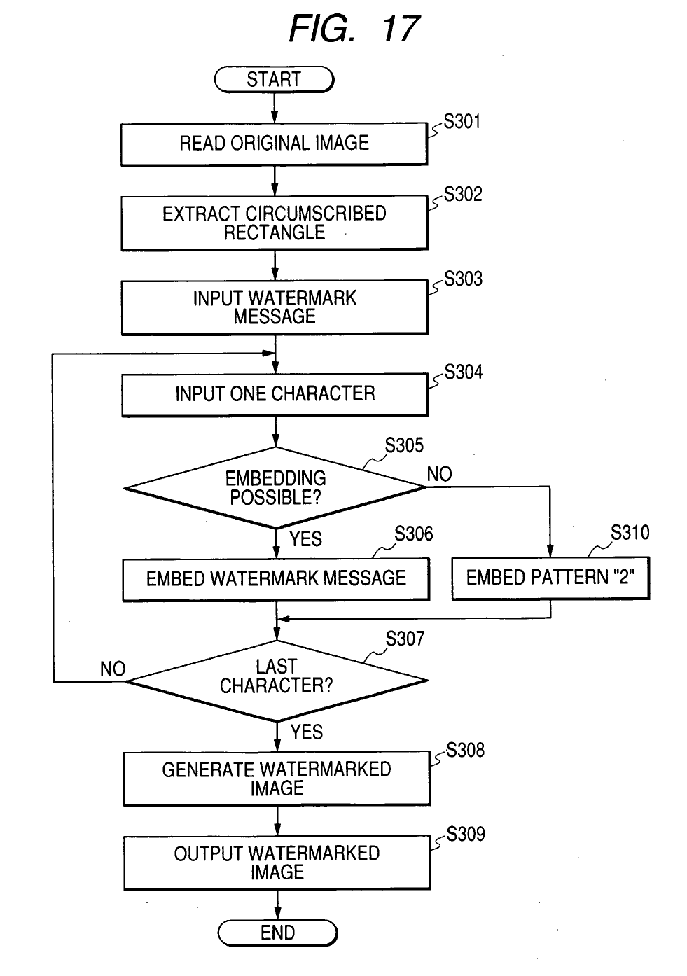

Here, it should be noted that the constitution and the processing procedure necessary in the operation on the watermark message embedding side in the modification 2 are substantially the same as those necessary in the operation of the first embodiment except for the following point. That is, in the first embodiment, if the judged result in the step S305 is NO, the flow returns to the step S304 (FIG. 3). On the other hand, in the modification 2 as shown in FIG. 17, if the judged result in the step S305 is NO, the flow advances to a step S310, and then the flow further advances to the step S307. Therefore, in the following, only the point different from the first embodiment will be explained in detail.

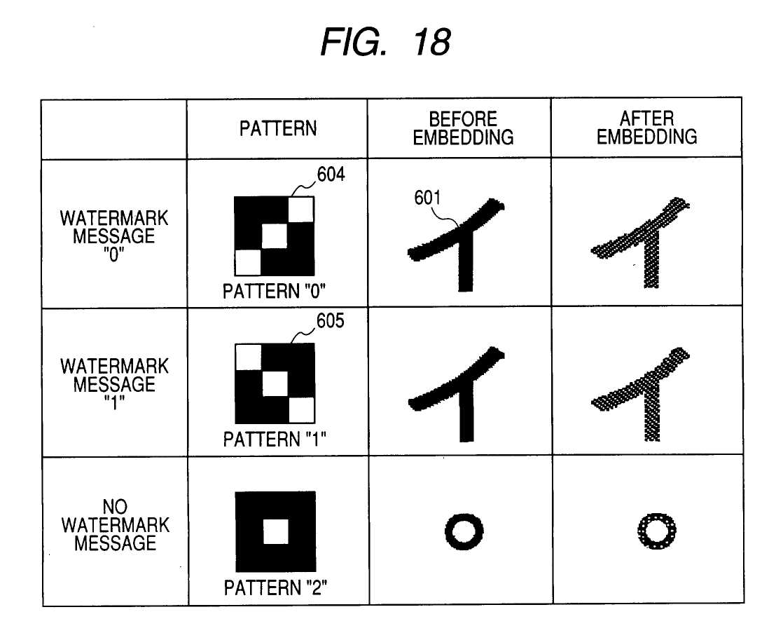

FIG. 18 is a diagram for explaining the changes of the character before and after the embedding of the watermark message, according to the modification 2. More specifically, in the modification 2, the procedure of embedding the watermark message by using the pattern “0” and the pattern “1” is the same as that in the first embodiment. Besides, if it is judged in the step S305 that the watermark message cannot be embedded in the input character (NO in step S305), the flow advances to the step S310 in FIG. 17 to constitute the character by using a pattern “2”. Here, the character in which the watermark message cannot be embedded is, for example, a too small character, code or the like. Further, the pattern “2” is different from the pattern “1” and the pattern “0”. More specifically, as the pattern “2”, it is desirable to use the pattern which is not erroneously recognized as the pattern “1” or the pattern “0”.

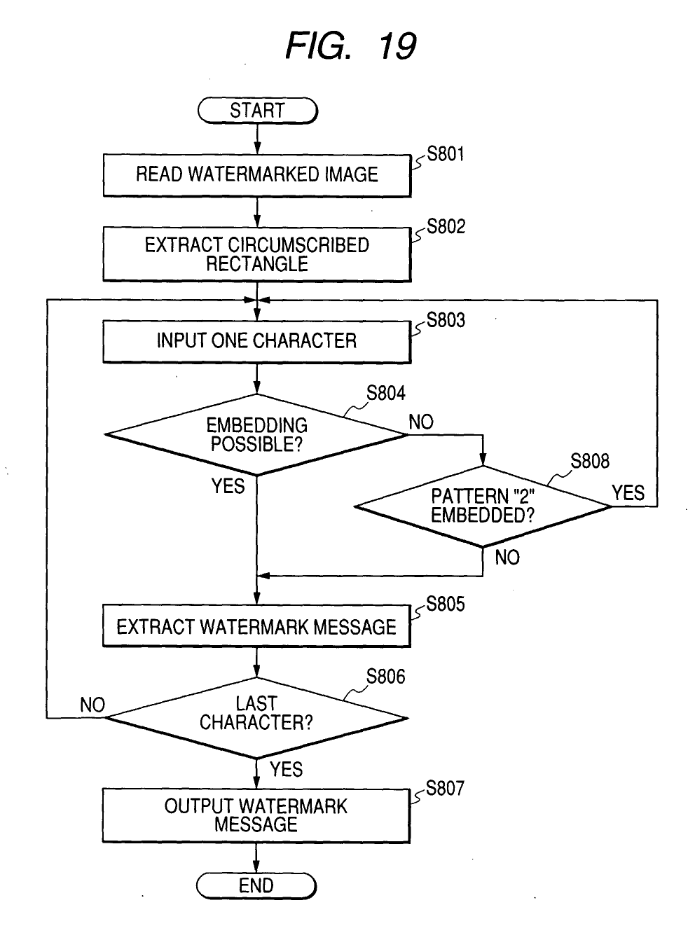

Here, it should be noted that the constitution and the processing procedure necessary in the operation on the watermark message extraction side in the modification 2 are substantially the same as those necessary in the operation of the first embodiment except for the point that, in FIG. 19, a step S808 is added to the processes from the step S804 to the step S805 shown in FIG. 9.

In FIG. 19, it is judged in the step S804 whether or not the area of the circumscribed rectangle of the input character is the area of the character in which the watermark message has been embedded. Then, if it is judged that the area of the circumscribed rectangle of the input character is the area of the character in which the watermark message has been embedded (YES in step S804), the flow advances to the step S805 to extract the watermark message.

Meanwhile, if it is judged that the area of the circumscribed rectangle of the input character is not the area of the character in which the watermark message has been embedded (NO in step S804), the flow advances to the step S808 to judge whether or not the pattern “2” has been embedded in the character.

If it is judged that the pattern “2” has been embedded in the character (YES in step S308), the flow returns to the step S803 to input next one character. Meanwhile, if it is judged that the pattern “2” is not embedded in the character (NO in step S308), the flow advances to the step S805 to extract the watermark message.

As described above, in the modification 2, the different pattern has been embedded in the character in which the watermark message is not embedded. Then, even in case of executing the watermark message extraction process, the extraction of the watermark message is not executed in regard to the character constituted by the pattern “2”, whereby it is possible to prevent that the watermark message is erroneously detected. Moreover, the character in which the watermark message is not embedded is constituted by using the predetermined pattern, whereby it is possible to obscure the density difference between the character in which the watermark message is not embedded and the character in which the watermark message has been embedded.

### Second Embodiment

The second embodiment of the present invention will be explained hereinafter. That is, in the second embodiment, the present invention is further modified so as to be able to extract the watermark message even in a case where the character size of the image optically read by a scanner or the like is larger or smaller than the character size when the watermark message was embedded. Here, it should be noted that the constitution and the processing procedure necessary in the operation on the watermark message embedding side in the second embodiment are the same as those necessary in the operation of the first embodiment. Moreover, it should be noted that the constitution and the processing procedure necessary in the operation on the watermark message extraction side in the second embodiment are the same as those necessary in the operation of the first embodiment except for the step S805 in the first embodiment. Therefore, in the following, only the point different from the first embodiment will be explained in detail.

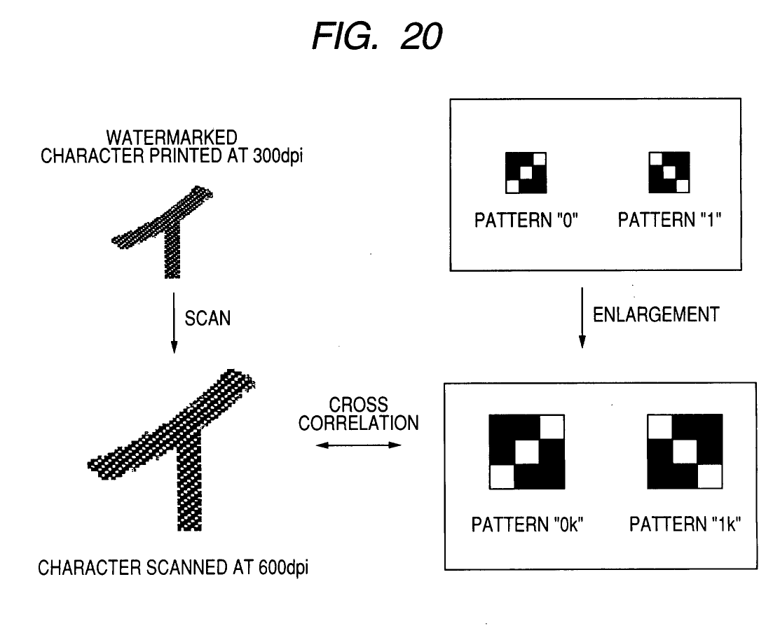

FIG. 20 is a diagram for explaining the size change of the pattern for extracting the watermark message in the second embodiment.

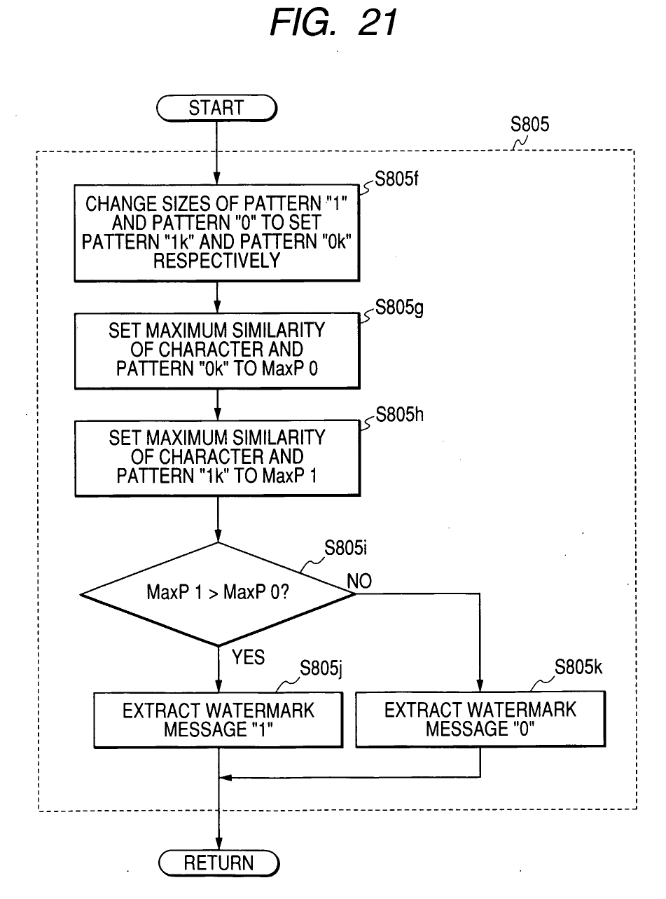

FIG. 21 is a flow chart for explaining the step S805 in the second embodiment.

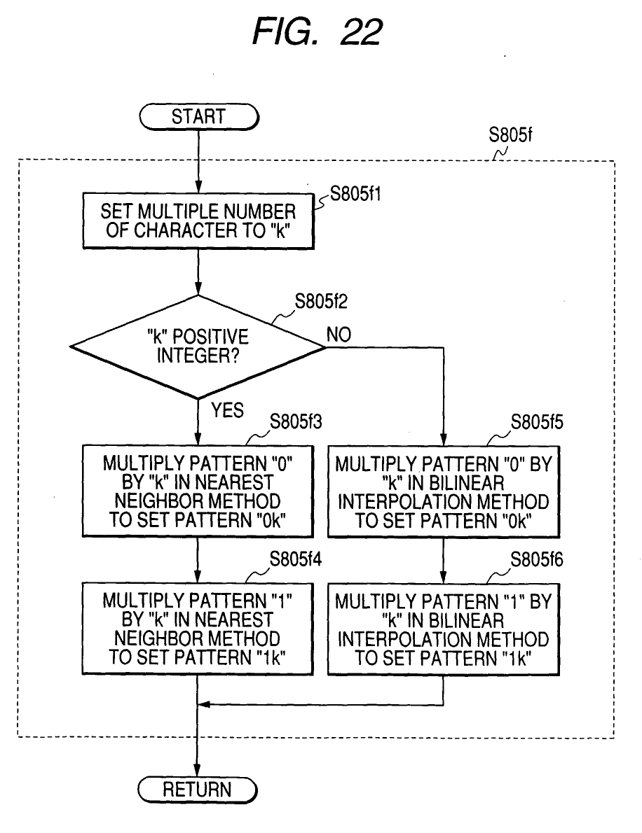

Initially, in a step S805f, the sizes of the pattern “0” and the pattern “1” are changed respectively to set a pattern “0k” and a pattern “1k”. Subsequently, the step S805f will be explained in detail with reference to a flow chart shown in FIG. 22.

FIG. 22 is the flow chart for explaining the method of enlarging the pattern in the second embodiment.

First, the resolution is acquired from a watermarked image file optically read by a scanner etc. Then, the acquired resolution is divided by the resolution at the time when the former watermarked image is printed, and the acquired value is set as a multiple number k of the character (step S805f1). Incidentally, it should be noted that the resolution at the time when the watermarked image is printed is necessary at the time when the watermark message is extracted, and the resolution may therefore be stored in the memory unit in advance or memorized secretly by the user as the key for the watermark message extraction process. For example, in a case where the former watermark message document printed at the resolution 300 dpi is optically read by the scanner or the like at the resolution 600 dpi, the multiple number k is “2”.

Then, it is judged whether or not the multiple number k is a positive integer (step S805f2). If it is judged that the multiple number k is the positive integer (YES in step S805f2), the pattern “0” is multiplied (enlarged) by “k” in the nearest neighbor method to acquire the pattern “0k” (step S805f3), and the pattern “1” is then multiplied (enlarged) by “k” in the nearest neighbor method to acquire the pattern “1k” (step S805f4). Meanwhile, if it is judged that the multiple number k is not the positive integer (NO in step S805f2), the pattern “0” is multiplied (enlarged) by “k” in the bilinear interpolation method to acquire the pattern “0k” (step S805f5), and the pattern “1” is then multiplied (enlarged) by “k” in the bilinear interpolation method to acquire the pattern “1k” (step S805f6).

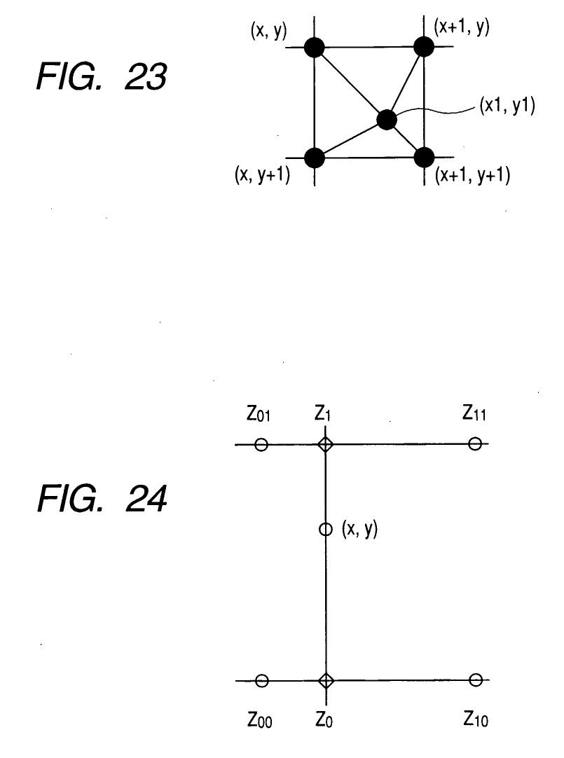

Subsequently, the nearest neighbor method will be explained with reference to FIG. 23. In FIG. 23, it is assumed that the respective values at the four points (x, y), (x, y+1), (x+1, y) and (x+1, y+1) are the already known values. In the circumstances, the value at the point (x1, y1) is acquired. At that time, the value at the nearest point from among the four points is set as the value at the point (x1, y1). That is, in FIG. 23, the value at the point (x+1, y+1) is the value at the point (x1, y1).

Moreover, the bilinear interpolation method will be explained with reference to FIG. 24. In FIG. 24, it is assumed that Z₀₀ indicates the already known value at the point (0, 0), Z₀₁ indicates the already known value at the point (0, 1), Z₁₀ indicates the already known value at the point (1, 0), and Z₁₁ indicates the already known value at the point (1, 1). In the circumstances, the value Z at the point (x, y) is acquired.

First, the value Z₀ at the point (x, 0) is acquired by using the values Z₀₀ and Z₁₀ according to the following equation.

Z₀=x×Z₁₀+(1−x)×Z₀₀

Then, the value Z₁ at the point (x, 1) is acquired by using the values Z₀₁ and Z₁₁ according to the following equation.

Z₁=x×Z₁₁+(1−x)×Z₀₁

Finally, the value Z at the point (x, y) is acquired by using the values Z₀ and Z₁ according to the following equation.

Z=x×Z₁+(1−y)×Z₀

Incidentally, the correction amounts at the relevant point in the x and y axes are acquired by respectively executing the bilinear interpolation to the x and y axes.

Then, in a step S805g shown in FIG. 21, the cross correlation between the character from which the watermark is to be extracted and the pattern “0k” is acquired, and the maximum value MaxP0 is acquired from the similarity (the set of matches) acquired through the cross correlation. Next, in a step S805h shown in FIG. 21, the cross correlation between the character and the pattern “1k” is acquired, and the maximum value MaxP1 is acquired from the similarity (the set of matches) acquired through the cross correlation.

Next, it is judged whether or not the maximum value MaxP1 is larger than the maximum value MaxP0 (step S805i). Then, if it is judged that the maximum value MaxP1 is larger than the maximum value MaxP0 (YES in step S805i), “1” is extracted as the watermark message (step S805j). Meanwhile, if it is judged that the maximum value MaxP1 is smaller than the maximum value MaxP0 (NO in step S805i), “0” is extracted as the watermark message (step S805k).

Therefore, even if the size of the character optically read by the scanner or the like changes, it is possible to correctly extract the watermark message.

### <Modification 1>

Subsequently, the modification 1 of the second embodiment will be explained hereinafter. That is, the present invention is further modified so as to be able to extract the watermark message even in a case where it is impossible to know how much the document image optically read by the scanner or the like is enlarged or reduced (namely, multiplied) as compared with the document image at the time when the watermark message is embedded. In the step S805f1 in the second embodiment, the magnification of enlarging (or reducing) the character can be acquired from the scan information or the like. On the other hand, in the modification 1 of the second embodiment, it is assumed that the magnification of enlarging (or reducing) the character cannot be acquired from the existing information.

Here, it should be noted that the constitution and the processing procedure necessary in the operation in the modification 1 are substantially the same as those necessary in the operation of the second embodiment except for the step S805f1. Therefore, in the following, only the point different from the second embodiment will be explained in detail.

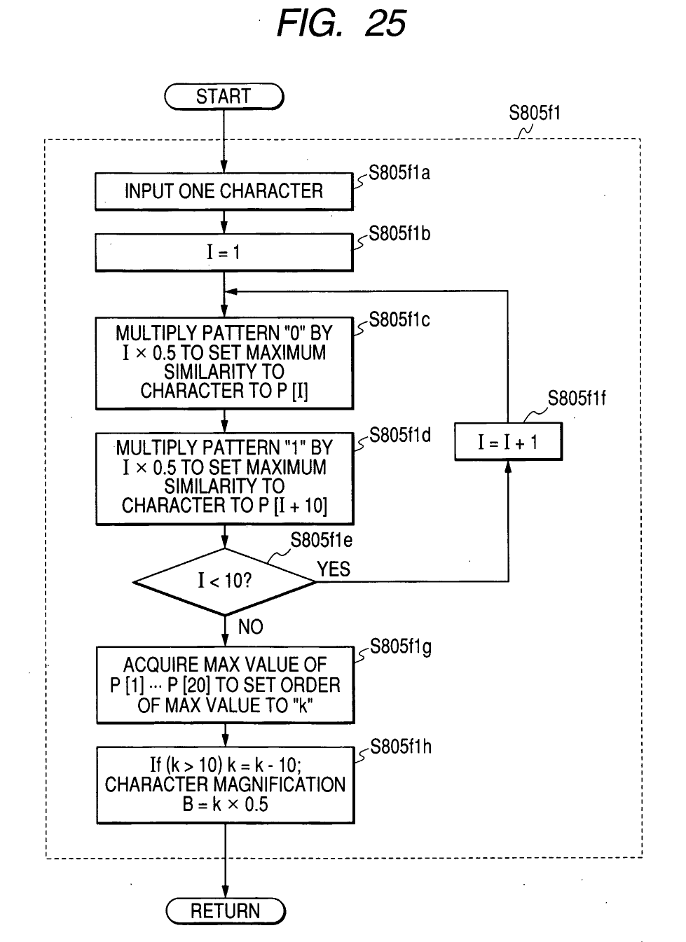

FIG. 25 is a flow chart for explaining the step S805f1 in the modification 1 of the second embodiment.

Initially, in a step S805f1a, one character which is judged that the watermark message has been embedded therein is input. Then, in a step S805f1b, “1” is given to a parameter I.

Subsequently, in a step S805f1c, the size of the pattern “0” is multiplied by I×0.5 to acquire the maximum similarity to the character. Here, it is assumed that the maximum similarity acquired in case of the parameter I is P[I]. For example, the maximum similarity is P[2] in case of I=2.

Likewise, in a step S805f1d, the size of the pattern “1” is multiplied by I×0.5 to calculate the maximum similarity to the character. Then, the calculated maximum similarity is given to P[I+10].

Subsequently, in a step S805f1e, it is judged whether or not the parameter I is smaller than “10”.

If it is judged that the parameter I is smaller than “10” (YES in step S805f1e), the flow advances to a step S805f1f to give the parameter I=I+1. Next, the flow returns to the step S805f1c to calculate the next parameter P[I].

Meanwhile, if it is judged that the parameter I is equal to or larger than “10” (NO in step S805f1e), the flow advances to a step S805f1g to acquire the maximum value from among the similarities P[1] to P[20]. Then, the order of the maximum value is set to “K”. For example, if the similarity P[15] has the maximum value, the order K is “15”.

Subsequently, in a step S805f1h, if the order K is larger than “10”, K=K−10 is set, and K×0.5 is then acquired and given to a magnification B of the extracted image to be acquired.

Incidentally, the parameter I×0.5 is set in the step S805f1c and the step S805f1d so as to enlarge the pattern in units of 0.5 magnification. However, it is needless to say that “0.5” may further be reduced to acquire the magnification more finely. Moreover, even if the maximum similarity is once calculated in units of 0.5 magnifications, it is then possible to again acquire the maximum similarity by reducing the unit of magnification in the magnification region having the higher maximum similarity.

In any case, the range of the parameter I is designated from “1” to “10” in the modification 1 of the second embodiment. However, it is apparent that the present invention is not limited to this.

Further, in the above explanation, the magnifications are sequentially changed to “same size” to infer the magnifications of enlarging and reducing the size. On the other hand, it is assumed that the sizes of the original before and after the size change can be inferred to some extent. For example, an A4 size is often enlarged to a B4 size and an A3 size. In such a case, if the magnifications of enlarging and reducing the size acquired from the inferred sizes are applied, it is possible to further effectively infer the magnifications of enlarging and reducing the size.

As described above, in the modification 1 of the second embodiment, even in the case where it is impossible to know how much the watermarked image optically read by the scanner or the like is enlarged or reduced (namely, multiplied) as compared with the watermarked image at the time when the watermark message is embedded, it is possible to extract the watermark message as inferring the magnification of such enlargement or reduction.

### Third Embodiment

The third embodiment of the present invention will be explained hereinafter. That is, in the third embodiment, the present invention is further modified so as to be able to, even in a case where the angle of the document is inclined when the watermarked document image is optically read by the scanner or the like, correctly extract the watermark message by adjusting the angle of the document.

Here, it should be noted that the constitution and the processing procedure necessary in the operation of the third embodiment are the same as those necessary in the operation of the first embodiment except for the process in the step S302 in the first embodiment. Therefore, in the following, only the point different from the first embodiment will be explained in detail.

That is, in the third embodiment, the angle of the input document image is first adjusted in the step S302.

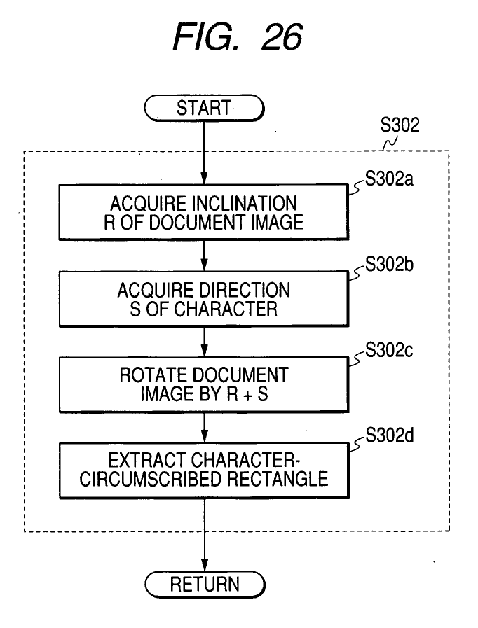

FIG. 26 is a flow chart for explaining the angle adjustment of the document image.

Initially, in a step S302a, an inclination amount R of the document image is acquired to make the row of the input document horizontal or vertical.

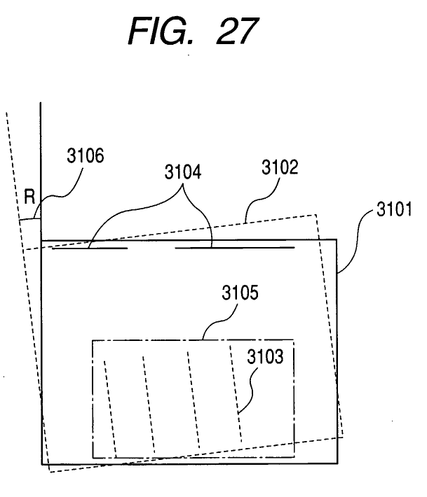

An example of the process of obtaining the inclination amount R will be explained with reference to FIG. 27. That is, in FIG. 27, a solid-line rectangle 3101 is the rectangle which represents the range of the input image, and a dotted-line rectangle 3102 is the rectangle which represents the inclination of the original. Here, it should be noted that the input image includes a document portion 3103 in a range 3105 and noises 3104, and the portion which is necessary in the input image is the document image.

Numeral 3106 denotes an angle which is equivalent to the inclination amount R to be acquired, and the angle 3106 is the angle between the solid-line rectangle 3101 and the dotted-line rectangle 3102. In the present embodiment, it should be noted that the method disclosed in Japanese Patent Application Laid-Open No. H09-006914 is used as the method of acquiring the inclination amount R. However, it is of course possible to use another method.

In the method disclosed in Japanese Patent Application Laid-Open No. H09-006914, the direction of a document is first detected automatically, the projections of the document in its row direction are acquired respectively through the two search windows arranged in the relevant row direction, one of the acquired projections is shifted toward the direction perpendicular to the relevant row direction, and the inclination amount of the document image is acquired from the shift amount and the distance from the window when the correlation between the projections comes to be maximum. Next, in a step S302b, a direction S of the character in the document image is acquired.

Here, the process of acquiring the character direction S will be explained in detail with reference to a flow chart shown in FIG. 28.

At first, in a step S302b1, one character is extracted from the document portion 3103.

Then, in a step S302b2, the extracted character is rotated by R degrees to execute inclination adjustment.

Next, in a step S302b3, the character is rotated in the four directions (0°, 90°, 180°, 270°) to execute character recognition.

In a step S302b4, the rotation angle at which the character recognition can be executed is given to the character direction S. For example, if the character recognition can be executed when the relevant character is rotated by 270°, then S=270 can be acquired.

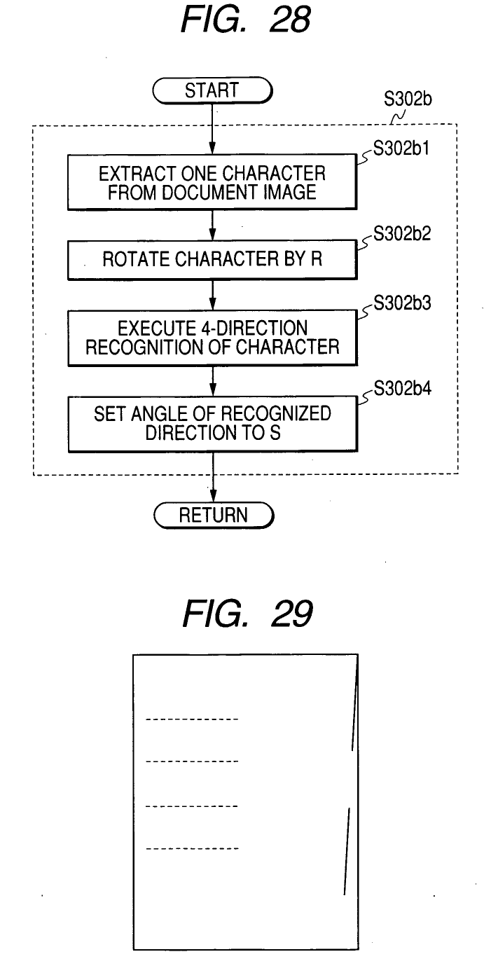

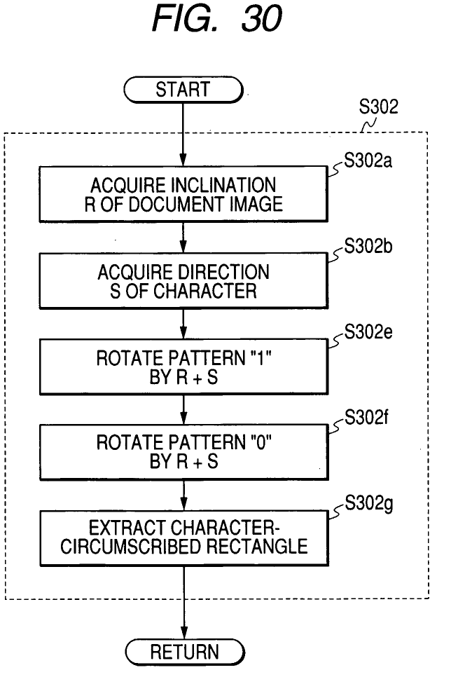

Subsequently, since the inclination of the document image and the direction of the character have been acquired in the steps S302a and S302b, then the input image is deformed in a step S302c so that the angle of the document image becomes correct. More specifically, it only has to rotate the input image only by (R+S) degrees around the barycenter of the input image. As a result, as shown in FIG. 29, the document image of which the angle has been corrected can be acquired from the input image shown in FIG. 27.

Next, in a step S302d, the circumscribed rectangle (i.e., character region) is extracted from the input document image by the document analysis unit 102. Here, it should be noted that the circumscribed rectangle is also called a character-circumscribed rectangle.

As a result, even if the angle of the document image which the Scanner or the like changes, it is possible to correctly extract the watermark message.

### <Modification 1>

Subsequently, the modification 1 of the third embodiment will be explained hereinafter. That is, the present invention is further modified so as to be able to, even in a case where the angle of the document is inclined when the watermarked document image is optically read by the scanner or the like, correctly extract the watermark message by rotating the pattern used in the extraction.

Here, it should be noted that the constitution and the processing procedure necessary in the operation of the modification 1 are the same as those necessary in the operation of the third embodiment except for the process in the step S302c in the third embodiment. Therefore, in the following, only the point different from the third embodiment will be explained in detail.

That is, in the modification 1, in the step S302, the angle of the input document image is first detected, and the pattern to be used for the watermark message extraction is rotated as well as the acquired angle.

FIG. 30 is a flow chart for explaining the rotation of the pattern.

First, in the step S302a, the inclination amount R of the document image is acquired to make the row of the input document horizontal or vertical.

Then, in the step S302b, the direction S of the character in the document image is acquired.

Subsequently, since the inclination of the document image and the direction of the character have been acquired in the steps S302a and S302b, then the angle of the pattern “1” is deformed in a step S302e. More specifically, it only has to rotate the input image only by (R+S) degrees around the barycenter of the pattern “1”. As a result, as shown in FIG. 29, the document image of which the angle has been corrected can be acquired from the input image shown in FIG. 27.

Next, in a step S302f, the input image is rotated by (R+S) degrees around the center of the pattern “0”. Incidentally, in the first embodiment, the maximum similarity to the character is acquired by using the pattern “1” and the pattern “0”, and then the watermark message is extracted. Meanwhile, in the modification 1, the pattern “1” and the pattern “0” which have been rotated by (R+S) degrees are used.

Subsequently, in a step S302g, the circumscribed rectangle (i.e., character region) is extracted from the input document image by the document analysis unit 102.

As a result, even if the angle of the document image which the scanner optically read or the like changes, it is possible to correctly extract the watermark message in the shortest time.

### <Modification 2>

Subsequently, the modification 2 of the third embodiment will be explained hereinafter. That is, the present invention is further modified so as to be able to, in case of acquiring the inclination amount of the document image, know the inclination amount of the document image by executing pattern matching as rotating the patterns.

Here, it should be noted that the constitution and the processing procedure necessary in the operation of the modification 2 are the same as those necessary in the operation of the third embodiment except for the process in the step S302a in the third embodiment. Therefore, in the following, only the point different from the third embodiment will be explained in detail.

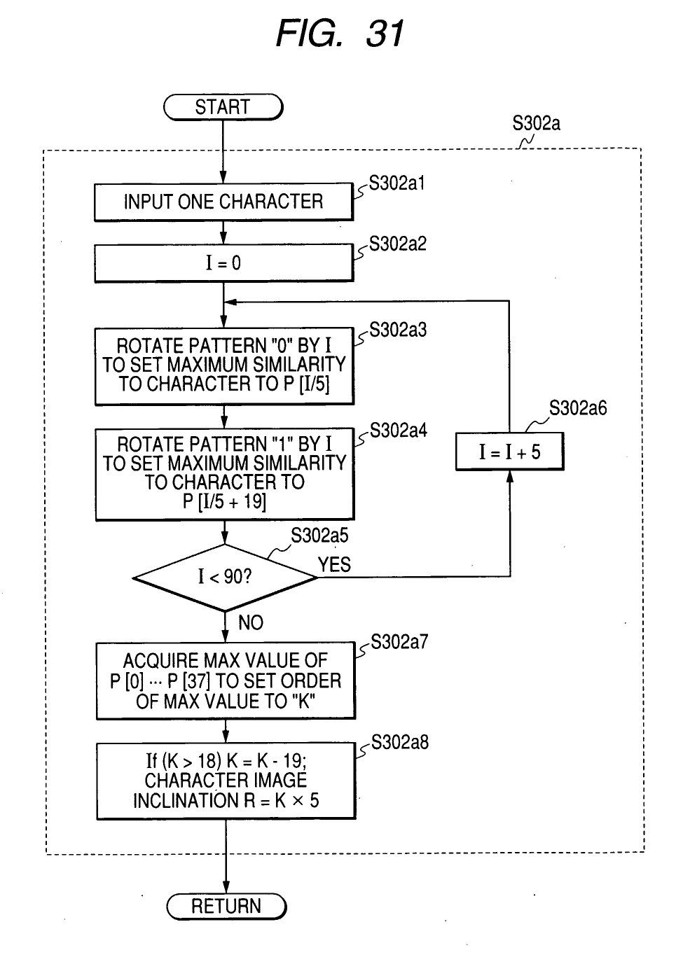

FIG. 31 is a flow chart for explaining the step S302a in the modification 2 of the third embodiment.

In the first instance, in a step S302a1, one character which is judged that the watermark message has been embedded therein is input.

Next, in a step S302a2, “0” is given to the parameter I.

Subsequently, in a step S302a3, the pattern “0” is rotated by I degrees to calculate the maximum similarity to the character. Then, the calculated maximum similarity is given to P[I/5]. For example, if I=10 degrees, the maximum similarity is given to P[2].

Likewise, in a step S302a4, the pattern “1” is rotated by I degrees to calculate the maximum similarity to the character. Then, the calculated maximum similarity is given to P[I/5+19].

Subsequently, in a step S302a5, it is judged whether or not the parameter I is smaller than “90”.

Then, if it is judged that the parameter I is smaller than “90” (YES in step S302a5), the flow advances to a step S302a6 to give the parameter I=I+5. Next, the flow returns to the step S302a3 to calculate the next parameter P[I/5].

Meanwhile, if it is judged that the parameter I is equal to or larger than “90” (NO in step S302a5), the flow advances to a step S302a7 to acquire the maximum value from among the similarities P[0] to P[37]. Then, the order of the maximum value is set to “K”. For example, if the similarity P[15] has the maximum value, the order K is “15”.

Subsequently, in a step S302a8, if the order K is larger than “18”, K=K−19 is set, and K×5 is then acquired and given to the inclination amount R of the document image to be acquired.

Incidentally, the parameter I+5 is set in the step S302a3 and the step S302a4 so as to rotate the pattern in units of “5” degrees. However, it is needless to say that “5” may further be reduced to divide the image more finely. Moreover, even if the maximum similarity is once calculated in units of “5” degrees, it is then possible to again acquire the maximum similarity by reducing the unit of rotation in the angle region having the higher maximum similarity.

In any case, in the present embodiment, since the pattern “1” is symmetrical with the pattern “0”, only the inclination amount of the document image can be calculated. On the other hand, if the pattern “1” is not symmetrical with the pattern “0”, “R+S” can be acquired by setting the parameter I to the angle from “0” degrees to “360” degrees. Incidentally, as described in the third embodiment, “R+S” is the sum of the inclination of the document image and the direction of the character.

As just described, according to the modification 2 of the third embodiment, even if the angle of the document image which was optically read by the scanner or the like changes, it is possible to correctly extract the watermark message by acquiring the rotation angle with use of the features of the patterns.

### Other Embodiments

It is needless to say that the object of the present invention can be achieved even in a case where the recording medium (or the storage medium) recording therein the program codes of software to realize the functions of the above embodiments is supplied to a system or an apparatus, and thus the computer (or the CPU, or the MPU) provided in the system or the apparatus reads and executes the program codes recorded in the recording medium. In this case, the program codes themselves read from the recording realize the functions of the above embodiments. Therefore, the recording medium storing the relevant program codes constitutes the present invention.

Further, it is needless to say that the present invention includes not only the case where the functions of the above embodiments are realized by executing the read-out program codes by the computer, but also a case where the OS (operating system) or the like running on the computer executes a part or all of the actual processes based on the instructions of the program codes and thus the functions of the above embodiments are realized by the relevant processes.

Furthermore, it is needless to say that the present invention also includes a case where, after the program codes read out of the recording medium were written into the memory provided in the function expansion card inserted in the computer or the function expansion unit connected to the computer, the CPU or the like provided in the function expansion card or the function expansion unit executes a part or all of the actual processes based on the instructions of the program codes, and thus the functions of the above embodiments are realized by the relevant processes.

In the case where the present invention is applied to the recording medium, the program codes which correspond to the above-explained flow charts are stored in the recording medium.

It is needless to say that the patterns to be used in the present invention are not limited to those explained in the above embodiments. That is, it is needless to say that the size (nine pixels in the above embodiments) of the pattern, the ratio of black and white pixels in the pattern, and the locations of the black and white pixels in the pattern are not limited to those explained in the above embodiments. Further, the ratio of the black and white pixels can arbitrarily be set in the pattern if the relevant pattern can be distinguished from other patterns. Incidentally, the two patterns are used in the above embodiments. However, the present invention is not limited to this. For example, if four patterns are used, it is possible to further embed a larger number of message data.

In case of embedding the watermark message bit “0”, the character may be constituted by the pattern “1”. On the other hand, in case of embedding the watermark message bit “1”, the character may be constituted by the pattern “0”. That is, if the watermark embedding side and the watermark extraction side share the same pattern, it only has to grasp for these sides which pattern corresponds to which message bit.

As explained above, it is assumed that the watermark message is embedded in the digital data, the relevant digital data is once printed, and then the digital data is again acquired by scanning the acquired printed material on which the relevant digital data has been printed. Even in this case, according to the above embodiments of the present invention, it is possible to maintain the state that the watermark message cannot easily be lost even after the digital data was printed.

Further, it is assumed that the watermark message is embedded in the digital data, the relevant digital data is once printed, and then the acquired printed material on which the relevant digital data has been printed is copied by the copying machine. Even in this case, according to the above embodiments of the present invention, the watermark message goes away, whereby it is possible to assure the originality of the digital data.

According to the above embodiments of the present invention, it is possible to achieve the embedding and the extracting of the watermark message which secures certain or more message embedding accuracy and amount as suppressing deterioration of quality in the original document image.

In other words, the foregoing description of the embodiments of the present invention has been given for illustrative purposes only and not to be construed as imposing any limitation in every respect.

The scope of the invention is, therefore, to be determined solely by the following claims and not limited by the text of the specifications and alterations made within a scope equivalent to the scope of the claims fall within the true spirit and scope of the invention.

This application claims priority from Japanese Patent Application No. 2005-114532 filed on Apr. 12, 2005, which is hereby incorporated by reference herein.

1. An image processing device comprising:
an image input unit adapted to input a document image;
an extraction unit adapted to extract a character image included in the input document image; and
an embedding unit adapted to embed a watermark message by constituting the character image by means of a predetermined dot pattern.

2. An image processing device according to claim 1, further comprising a detection unit adapted to detect a feature point from the character image extracted by said extraction unit,
wherein said embedding unit embeds the watermark message by constituting the detected feature point by means of the predetermined dot pattern.

3. An image processing device according to claim 1, further comprising a judgment unit adapted to judge whether or not the character image extracted by said extraction unit is a character in which the watermark message can be embedded.

4. An image processing device according to claim 3, wherein said embedding unit embeds the watermark message by constituting, by means of the predetermined dot pattern, the character image judged by said judgment unit that the watermark message can be embedded therein.

5. An image processing device according to claim 4, wherein said embedding unit further constitutes, by means of a dot pattern different from the predetermined dot pattern, the character image not judged by said judgment unit that the watermark message can be embedded therein.

6. An image processing device comprising:
an image input unit adapted to input a watermarked document image;
an acquisition unit adapted to acquire dot pattern information indicating a dot pattern constituting a character image included in the input document image; and
an extraction unit adapted to extract a watermark message based on the acquired dot pattern information constituting a character image.

7. An image processing device according to claim 6, wherein said acquisition unit acquires the dot pattern information based on cross correlation between the character image and a predetermined dot pattern.

8. An image processing device according to claim 7, further comprising:
an enlargement/reduction ratio acquisition unit adapted to acquire an enlargement/reduction ratio of the document image input by said image input unit to the document image acquired when the watermark message was embedded; and
a dot pattern enlargement/reduction unit adapted to enlarge/reduce the predetermined dot pattern according to the acquired enlargement/reduction ratio,
wherein said acquisition unit acquires the dot pattern information based on cross correlation between the character image and the enlarged/reduced predetermined dot pattern.

9. An image processing device according to claim 7, further comprising:
an enlargement/reduction ratio acquisition unit adapted to acquire an enlargement/reduction ratio of the document image input by said image input unit to the document image acquired when the watermark message was embedded; and
a document image enlargement/reduction unit adapted to enlarge/reduce the input document image according to the acquired enlargement/reduction ratio.

10. An image processing device according to claim 6, further comprising an adjustment unit adapted to adjust an angle of the input document image.

11. An image processing method comprising:
an image input step of inputting a document image;
an extraction step of extracting a character image included in the input document image; and
an embedding step of embedding a watermark message by constituting the character image by means of a predetermined dot pattern.

12. An image processing method according to claim 11, further comprising a detection step of detecting a feature point from the character image extracted in said extraction step,
wherein said embedding step is adapted to embed the watermark message by constituting the detected feature point by means of the predetermined dot pattern.

13. An image processing method according to claim 11, further comprising a judgment step of judging whether or not the character image extracted in said extraction step is a character in which the watermark message can be embedded.

14. An image processing method according to claim 13, wherein said embedding step is adapted to embed the watermark message by constituting, by means of the predetermined dot pattern, the character image judged in said judgment step that the watermark message can be embedded therein.

15. An image processing method according to claim 14, wherein said embedding step is adapted to further constitute, by means of a dot pattern different from the predetermined dot pattern, the character image not judged in said judgment step that the watermark message can be embedded therein.

16. An image processing method comprising:
an image input step of inputting a watermarked document image;
an acquisition step of acquiring dot pattern information indicating a dot pattern constituting a character image included in the input document image; and
an extraction step of extracting a watermark message based on the acquired dot pattern information constituting the character image.

17. An image processing method according to claim 16, wherein said acquisition step is adapted to acquire the dot pattern information based on cross correlation between the character image and a predetermined dot pattern.

18. A control program for causing a computer to execute an image processing method comprising:
an image input step of inputting a document image;
an extraction step of extracting a character image included in the input document image; and
an embedding step of embedding a watermark message by constituting the character image by means of a predetermined dot pattern.

19. A computer-readable storage medium which stores therein a control program for causing a computer to execute an image processing method comprising:
an image input step of inputting a document image;
an extraction step of extracting a character image included in the input document image; and
an embedding step of embedding a watermark message by constituting the character image by means of a predetermined dot pattern.

20. A control program for causing a computer to execute an image processing method comprising:
an image input step of inputting a watermarked document image;
an acquisition step of acquiring dot pattern information indicating a dot pattern constituting a character image included in the input document image; and
an extraction step of extracting a watermark message based on the acquired dot pattern information constituting the character image.

21. A computer-readable storage medium which stores therein a control program for causing a computer to execute an image processing method comprising:
an image input step of inputting a watermarked document image;
an acquisition step of acquiring dot pattern information indicating a dot pattern constituting a character image included in the input document image; and
an extraction step of extracting a watermark message based on the acquired dot pattern information constituting the character image.
